(19) United States
(12) Patent Application Publication
(10) Pub. No.: US 2025/0348823 A1
(43) Pub. Date: Nov. 13, 2025

(54) HEALTH ASSESSMENT METHOD OF AN AQUATIC ECOSYSTEM BASED ON ECOLOGICAL INTEGRITY AND AN APPLICATION THEREOF

(71) Applicant: Beijing Normal University, Beijing (CN)

(72) Inventors: Yujun Yi, Beijing (CN); Jingxu Ye, Beijing (CN)

(21) Appl. No.: 19/204,733

(22) Filed: May 12, 2025

(30) Foreign Application Priority Data
May 13, 2024 (CN) 2024105923454

(51) Int. Cl. G06Q 10/0639; G06Q 50/06

(52) U.S. Cl. CPC G06Q 10/06393; G06Q 50/06

(57) ABSTRACT

A health assessment method of the aquatic ecosystem based on ecological integrity and an application method thereof are provided. An assessment indicator system is constructed and divided into four layers: a goal layer, a criterion layer, an element layer, and an indicator layer. For different indicator types, differentiated baseline determination methods are used to obtain ecological baselines based on the ecological integrity. For core indicators, a method combining an entropy weight method and an analytic hierarchy process is used to conduct both quantitative and qualitative analyses. Ultimately, a health status of the aquatic ecosystem is displayed in an easily understandable format through graphical annotations and pattern-based zoning. In summary, this method can comprehensively and scientifically evaluate the health status of the aquatic ecosystem. It helps to advance the assessment of the aquatic ecosystem and provides a scientific basis for the management and restoration of the aquatic ecosystem.

### CROSS-REFERENCE TO RELATED APPLICATION

This application claims priority to Chinese Patent Application No. 202410592345.4, filed May 13, 2024, which is herein incorporated by reference in its entirety.

### TECHNICAL FIELD

The disclosure relates the field of aquatic ecosystems, and more particularly to a health assessment method of an aquatic ecosystem based on ecological integrity and an application method thereof.

### BACKGROUND

Ecological integrity of aquatic ecosystems refers to structural and functional integrity of the aquatic ecosystems. The aquatic ecosystems have important ecological functions such as energy supply and power generation, waterway transportation, purification and regulation, and maintenance of biodiversity, thereby supporting and serving the development and progress of human society. However, under the influence of extreme climatic events and intensive human activities, the aquatic ecosystems face a series of ecological problems, such as degraded habitat quality, excessive pollutants, and species extinction. There is an urgent need for a scientific and comprehensive method for assessing the aquatic ecosystems to guide the management and restoration of these aquatic ecosystems.

Therefore, problems existing in the related art need further improvement and development.

### SUMMARY

To solve problems existing in the related art, a purpose of the disclosure is to provide a health assessment method of an aquatic ecosystem based on ecological integrity and an application method thereof.

To solve the above technical problems, the disclosure provides a health assessment method of an aquatic ecosystem based on ecological integrity, including:
step 1, determining criteria consisting of physical habitat, physicochemical properties, and aquatic organisms of the aquatic ecosystem to obtain criterion layers, and obtaining ecological baseline values of candidate indicators by using differentiated ecological baseline determination methods;
step 2, sequentially performing applicability verification, sensitivity verification, and redundancy verification on the candidate indicators in that order to select core indicators from the candidate indicators;
step 3, performing weighting and summing on the criterion layers of the aquatic ecosystem by using a method combining an entropy weight method and an analytic hierarchy process, to thereby obtain a comprehensive score of the aquatic ecosystem; and
step 4, determining a level result of the aquatic ecosystem according to the comprehensive score of the aquatic ecosystem and assessment standard levels and displaying the level result of the aquatic ecosystem.

In an embodiment, the obtaining ecological baseline values of candidate indicators by using differentiated ecological baseline determination methods includes:
in response to a target candidate indicator of the candidate indicators being an indicator of a site with a lower variability, a stronger continuity, or a slower response to external stressors, determining an ecological baseline of the target candidate indicator by using a historical reference method, and using a historical state of the site prior to human activity interference as an ecological baseline value of the target candidate indicator;
in response to a target candidate indicator of the candidate indicators being an indicator of a site with a higher variability, a poorer continuity, or a faster response to external stressors, determining an ecological baseline of the target candidate indicator by using a reference site method, and using a state of a site with a minimal human disturbance of sampling sites as an ecological baseline value of the target candidate indicator.

In an embodiment, the performing applicability verification includes:
calculating a coefficient of variation for each of the candidate indicators as per the following formula: Cᵥ=σ/μ, where μ represents a standard deviation of each of the candidate indicators, and σ represents an average value of each of the candidate indicators; and removing all candidate indicators with the coefficient of variation Cᵥ≤0.15 from the candidate indicator to obtain applicability-verified candidate indicators;

the performing sensitivity verification includes:
comparing ecological baseline values R and sample values S of the applicability-verified candidate indicators by using a boxplot method; and removing applicability-verified candidate indicators with an indicator quality (IQ) less than 2 from the applicability-verified candidate indicators to obtain sensitivity-verified candidate indicators; and

the performing redundancy verification includes:
performing a Pearson correlation analysis on the sensitivity-verified candidate indicators; and in response to two candidate indicators of the sensitivity-verified candidate indicators having a correlation coefficient |r|≥0.95, retaining only one of the two candidate indicators of the sensitivity-verified candidate indicators.

In an embodiment, the step 3 includes:
step 301, normalizing data of the core indicators;
step 302, weighting the core indicators by using the entropy weight method, and calculating a score of each of the criterion layers through weight summation; and
step 303, weighting each of the criterion layers by using the analytic hierarchy process, thereby calculating the comprehensive score of the aquatic ecosystem.

In an embodiment, the normalizing data of the core indicators includes:
for a target core indicator being a positive indicator of the core indicators, normalizing data of the target core indicator as per a formula (a):

$$s = ( x - {x}_{m i n} ) / ( {x}_{m ax} - {x}_{m i n} ) \qquad ( a )$$

for a target core indicator being a negative indicator of the core indicators, normalizing data of the target core indicator as per a formula (b):

$$s = ( {x}_{m ax} - x ) / ( {x}_{m ax} - {x}_{m i n} ) \qquad ( b )$$

where s represents a normalized value of the target core indicator, x represents a measured value of the target core indicator, xₘₐₓ represents a maximum measured value of the target core indicator, and xₘᵢₙ represents a minimum measured value of the target core indicator.

In an embodiment, the weighting the core indicators by using the entropy weight method, and calculating a score of each of the criterion layers through weight summation includes:
weighting the core indicators of each of the criterion layers by using the entropy weight method; and calculating the score of each of the criterion layers as per formulas (c), (d), and (e), respectively:

$$P = 100 * \sum ( {p}_{i} * {w}_{pi} ) \qquad ( c )$$

$$C = 10 \; 0 * \sum ( {c}_{i} * {w}_{ci} ) \qquad ( d )$$

$$B = 10 \; 0 * \sum ( {b}_{i} * {w}_{bj} ) \qquad ( e )$$

where P represents a score for the physical habitat, pᵢ represents a normalized value of a i-th indicator of the physical habitat, and wₚᵢ represents a weight of the i-th indicator of the physical habitat; C represents a score for the physicochemical properties, c¿ represents a normalized value of a i-th indicator of the physicochemical properties, and w_{ci} represents a weight of the i-th indicator of the physicochemical properties; and B represents a score for the aquatic organisms, bᵢ represents a normalized value of a i-th indicator of the aquatic organisms, and w_{bj} represents a weight of the i-th indicator of the aquatic organisms.

In an embodiment, the comprehensive score of the aquatic ecosystem is calculated as per a formula (f):

$$EHI = P * {W}_{P} + C * {W}_{C} + B * {W}_{B}$$

where EHI represents the comprehensive score of the aquatic ecosystem, W_{P} represents a weight of the physical habitat, W_{C} represents a weight of the physicochemical properties, and W_{B} represents a weight of the aquatic organisms.

In an embodiment, the assessment standard levels consist of five levels corresponding to a health status of the aquatic ecosystem: very healthy, healthy, sub-healthy, unhealthy, and degraded.

In an embodiment, the displaying the level result of the aquatic ecosystem includes:
displaying a health status of the aquatic ecosystem, based on the assessment standard levels and by using graphical annotations and pattern-based zoning.

In an embodiment, the health assessment method of the aquatic ecosystem based on the ecological integrity is executable by one or more processors and further includes: sending, by a processor, the level result of the aquatic ecosystem to a mobile terminal of management personnel, and displaying the score for the physical habitat, the score for the physicochemical properties, and the score for the aquatic organisms on the mobile terminal to thereby assist the management personnel to make decisions regarding ecological restoration and management strategies. In addition, the health assessment method also includes sending additional warning information by highlighting the limiting indicators with low scores to the mobile terminal of the management personnel when the level result of the aquatic ecosystem is degraded, and displaying immediate measures including emergency water quality treatment and removal of invasive species on the mobile terminal, thereby allowing the management personnel to take the immediate measures to stabilize the aquatic ecosystem.

In an embodiment, the health assessment method of the aquatic ecosystem based on the ecological integrity further includes the following actions in response to the level result of the aquatic ecosystem:
in response to the level result of the aquatic ecosystem being very healthy, which indicates that structures and functions of the physical habitat, the physicochemical properties, and the aquatic organisms are intact, the management personnel take routine maintenance activities to sustain the health status of the aquatic ecosystem, such as conducting periodic inspections of the physical habitat (e.g., riparian zones, lakebeds, wetlands) using automated sensors and drones to detect any physical disturbances, and preventing any invasive species that may threaten ecological balance of the aquatic ecosystem;
in response to the level result of the aquatic ecosystem being healthy, which indicates that structures and functions of the physical habitat, the physicochemical properties, and the aquatic organisms are essentially intact, the management personnel take preventive maintenance measures to protect the health status of the aquatic ecosystem, such as reinforcing riparian zones to prevent erosion and conducting regular inspections to identify potential issues early;
in response to the level result of the aquatic ecosystem being sub-healthy, which indicates that there are certain deficiencies in structures and functions of the physical habitat, the physicochemical properties, and the aquatic organisms, the management personnel take improvement measures to improve the health status of the aquatic ecosystem, such as planting native vegetation along riparian zones to stabilize soil and improve water quality of the aquatic ecosystem;
in response to the level result of the aquatic ecosystem being unhealthy, which indicates that there are significant deficiencies in structures and functions of the physical habitat, the physicochemical properties, and the aquatic organisms, the management personnel take remediation measures to improve the health status of the aquatic ecosystem, such as chemical treatment of contaminated water bodies of the aquatic ecosystem, biological remediation using microorganisms to degrade pollutants, and reintroducing native species to enhance biodiversity;
in response to the level result of the aquatic ecosystem being degraded, which indicates that integrity of structures and functions of the physical habitat, physicochemical properties, and aquatic organisms is severely compromised, the management personnel take comprehensive remediation strategies to restore the health status of the aquatic ecosystem, such as large-scale habitat reconstruction, advanced water treatment technologies (such as nanoremediation), and use of engineered solutions (such as ecological flow regulation).

An application method of the health assessment method of the aquatic ecosystem based on the ecological integrity, includes:
assessing health statuses of river or lake ecosystems using the health assessment method, and
managing and restoring the river or lake ecosystems using the health assessment method.

The disclosure may achieve the following beneficial effects. The health assessment method of the aquatic ecosystem based on the ecological integrity and the application method thereof are provided by the disclosure. This method can comprehensively, scientifically, and accurately assess the health status of the aquatic ecosystem. It is conducive to promoting the assessment of the aquatic ecosystem and provides a scientific basis for the management and restoration of the aquatic ecosystem.

### BRIEF DESCRIPTION OF DRAWINGS

FIG. 1 illustrates a flowchart of a health assessment method of an aquatic ecosystem based on ecological integrity provided by the disclosure.

FIG. 2 illustrates a flowchart for selecting core indicators.

FIG. 3 illustrates a schematic diagram of results of sensitivity verification.

FIG. 4 illustrates a flowchart of a method combining an entropy weight method and an analytic hierarchy process.

FIG. 5 illustrates a coefficient of variation of each of candidate indicators according to an embodiment.

FIGS. 6A-6E illustrates boxplots of reference values R and sample values S of sensitivity-verified candidate indicators according to the embodiment.

FIG. 7 illustrates a zoning diagram of a health status of the aquatic ecosystem.

### DETAILED DESCRIPTION OF EMBODIMENTS

The following detailed description of the disclosure is provided in conjunction with a specific embodiment. More details are elaborated in the description to facilitate a thorough understanding of the disclosure. However, it is apparent that the disclosure can be implemented in various other ways different from the described embodiment. Those skilled in the art can make similar extensions and adaptations without departing from the spirit of the disclosure. Therefore, the specific content of the embodiment should not be used to limit the scope of protection of the disclosure.

A health assessment method of an aquatic ecosystem based on ecological integrity, as shown in FIG. 1, includes the following steps.

Step 1, criteria consisting of physical habitat, physicochemical properties, and aquatic organisms of the aquatic ecosystem are determined to obtain criterion layers, and ecological baseline values of candidate indicators are obtained by using differentiated ecological baseline determination methods.

Step 2, applicability verification, sensitivity verification, and redundancy verification are sequentially performed on the candidate indicators in that order to select core indicators from the candidate indicators.

Step 3, criterion layers of the aquatic ecosystem are weighted and summed by using a method combining an entropy weight method and an analytic hierarchy process to obtain a comprehensive score of the aquatic ecosystem.

Step 4, a level result of the aquatic ecosystem is determined according to the comprehensive score of the aquatic ecosystem and assessment standard levels, and the level result of the aquatic ecosystem is displayed.

Specific processes of the step 1 are as follows.

An assessment framework of “goal layer-criterion layer-element layer-indicator layer” is used. Based on the concept of the integrity of the aquatic ecosystem, an indicator system consisting of the three criterion layers of the physical habitat, the physicochemical properties, and the aquatic organisms is constructed, reflecting different aspects of the physical habitat, the physicochemical properties, and the aquatic organisms of the aquatic ecosystem.

Due to differences in continuity, variability, and response mechanisms of different types of the candidate indicators, the differentiated ecological baseline determination methods are used, which can more comprehensively and accurately reflect a health status of the aquatic ecosystem.

The differentiated ecological baseline determination methods are as follows.

In response to a target candidate indicator of the candidate indicators being an indicator of a site with a lower variability, a stronger continuity, or a slower response to external stressors, an ecological baseline of the target candidate indicator is determined by using a historical reference method, and a historical state of the site prior to human activity interference is used as an ecological baseline value of the target candidate indicator.

In response to a target candidate indicator of the candidate indicators being an indicator of a site with a higher variability, a poorer continuity, or a faster response to external stressors, an ecological baseline of the target candidate indicator is determined using a reference site method, and a state of a site with a minimal human disturbance of sampling sites is used as an ecological baseline value of the target candidate indicator.

Specifically, when selecting the candidate indicators, the candidate indicators include indicators of the physical habitat that reflect hydrological regime, spatial morphology, and riparian zone condition, indicators of the physicochemical properties that reflect water quality and sediment pollution, and indicators of the aquatic organisms that reflect phytoplankton integrity, zooplankton integrity, macroinvertebrate integrity, and fish integrity.

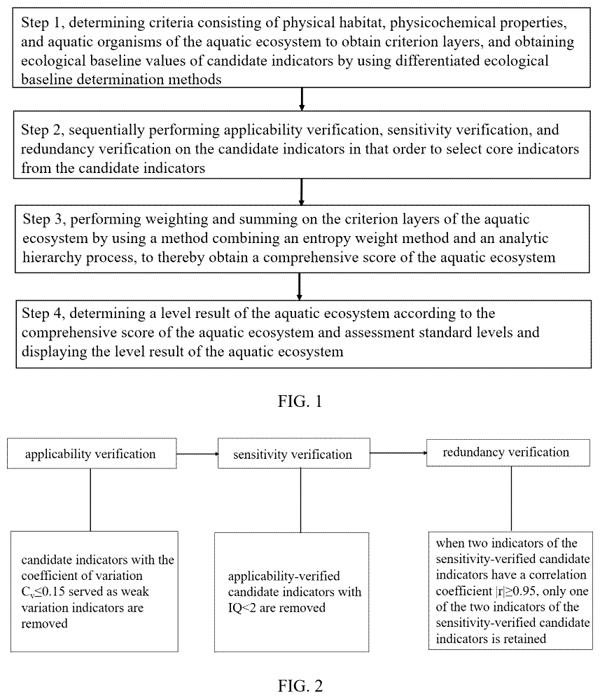

As shown in FIG. 2, specific processes of the step 2 are as follows.

The applicability verification is performed by calculating a coefficient of variation for each of the candidate indicators as per the following formula: Cᵥ=σ/μ, where μ represents a standard deviation of each of the candidate indicators, and σ represents an average value of each of the candidate indicators. Candidate indicators with the coefficient of variation Cᵥ≤0.15 from the candidate indicators, served as weak variation indicators, are removed to obtain applicability-verified candidate indicators.

The sensitivity verification is performed by comparing ecological baseline values R and sample values S of the applicability-verified candidate indicators by using a boxplot method; and applicability-verified candidate indicators with an IQ less than 2 from the applicability-verified candidate indicators are removed to obtain sensitivity-verified candidate indicators.

A specific method of the sensitivity verification is as follows.

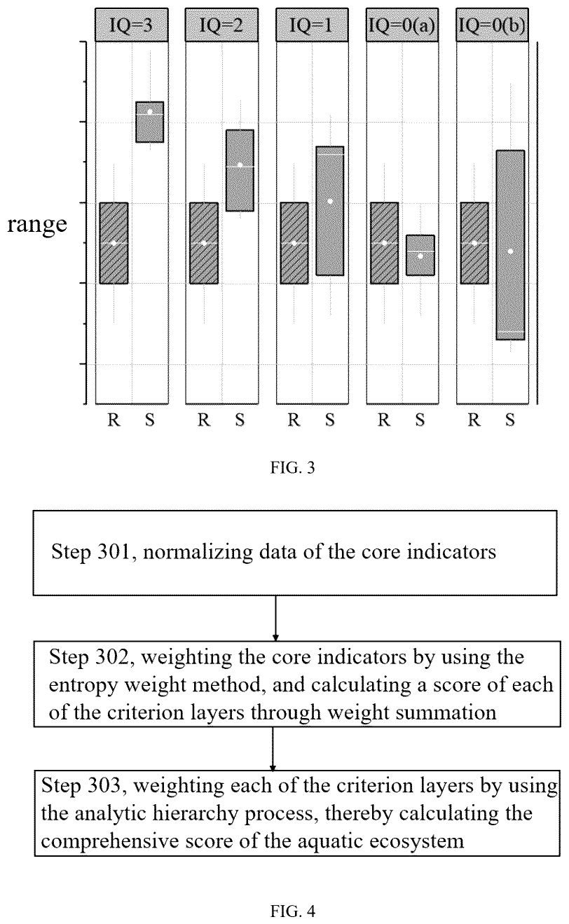

For each of the applicability-verified candidate indicators, a boxplot of ecological baseline values R is compared with a boxplot of sample values S. An IQ value is assigned to each of the applicability-verified candidate indicators based on an overlap range of the above two boxplots, as shown in FIG. 3.

If there is no overlap between quartile ranges of the ecological baseline values R and the sample values S for the applicability-verified candidate indicator, the IQ value is assigned as 3.

If the applicability-verified candidate indicator has only a smaller overlap between the quartile ranges of the ecological baseline values R and the sample values S, and medians of both are not within the quartile range of the other, the IQ value is assigned as 2.

If the applicability-verified candidate indicator has a larger overlap between the quartile ranges of the ecological baseline values R and the sample values S, and the median of one of the quartile ranges falls within the other of the quartile ranges, the IQ value is assigned as 1.

If the medians of the quartile ranges of the ecological benchmark values R and the sample values S for the applicability-verified candidate indicator are within the quartile range of each other (a) or almost completely overlap (b), the IQ value is assigned as 0.

It should be noted that when selecting indicators, those with IQ<2 should be removed. This is because when IQ<2, the ecological baseline values R and the sample values S cannot be distinguished and thus lack sensitivity.

The redundancy verification is performed by performing a Pearson correlation analysis on the sensitivity-verified candidate indicators. In response to two candidate indicators of the sensitivity-verified candidate indicators having a correlation coefficient |r|≥0.95, only one of the two candidate indicators of the sensitivity-verified candidate indicators is retained.

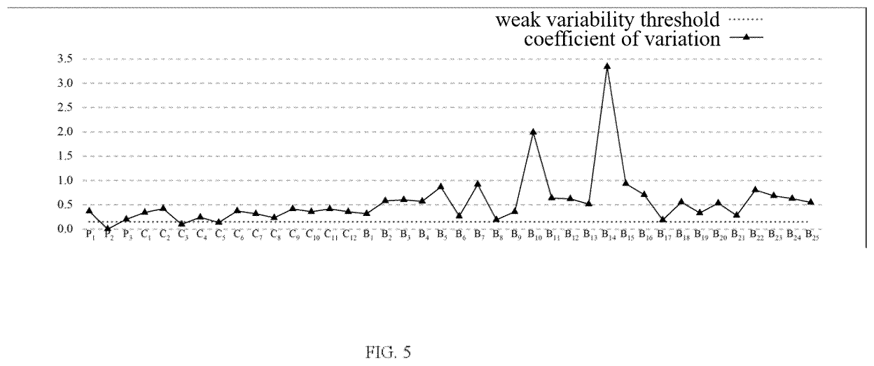

As shown in FIG. 4, the step 3 specifically includes the following steps. Step 301, data of the core indicators are normalized.

Due to different types of health assessment indicators (i.e., the core indicators) of the aquatic ecosystem, some core indicators are better when their values are higher (i.e., positive indicators), while other core indicators are better when their values are lower (i.e., negative indicators). Therefore, it is necessary to normalize the data of the core indicators to obtain normalized data. The normalized data, on a same order of magnitude, can eliminate the influence of dimensions and units between the core indicators, and improve the comparability between different data indicators.

For a target core indicator of the positive indicators, data of the target core indicator is normalized as per a formula (a):

$$s = ( x - {x}_{m i n} ) / ( {x}_{m ax} - {x}_{m i n} ) \qquad ( a )$$

for a target core indicator of the negative indicators, data of the target core indicator is normalized as per a formula (b):

$$s = ( {x}_{m a x} - x ) / ( {x}_{m ax} - {x}_{m i n} ) \qquad ( b )$$

where s represents a normalized value of the target core indicator, x represents a measured value of the target core indicator, xₘₐₓ represents a maximum measured value of the target core indicator, and xₘᵢₙ represents a minimum measured value of the target core indicator.

Step 302, the core indicators are weighted by using the entropy weight method, and a score of each of the criterion layers is calculated through weighted summation.

Specifically, the core indicators of each of the criterion layers are weighted by using the entropy weight method, and a score for the physical habitat, a score for the physicochemical properties, and a score for the aquatic organisms are calculated as per formulas (c), (d), and (e), respectively:

$$P = 100 * \sum ( {p}_{i} * {w}_{pi} ) \qquad ( c )$$

$$C = 10 \; 0 * \sum ( {c}_{i} * {w}_{ci} ) \qquad ( d )$$

$$B = 10 \; 0 * \sum ( {b}_{i} * {w}_{bj} ) \qquad ( e )$$

where P represents the score for the physical habitat, pᵢ represents a normalized value of a i-th indicator of the physical habitat, and wₚᵢ represents a weight of the i-th indicator of the physical habitat; C represents the score for the physicochemical properties, cᵢ represents a normalized value of a i-th indicator of the physicochemical properties, and w_{ci} represents a weight of the i-th indicator of the physicochemical properties; and B represents the score for the aquatic organisms, bᵢ represents a normalized value of a i-th indicator of the aquatic organisms, and w_{bj} represents a weight of the i-th indicator of the aquatic organisms.

Step 303, each of the criterion layers is weighted by using the analytic hierarchy process to calculate the comprehensive score of the aquatic ecosystem.

Specifically, the comprehensive score of the aquatic ecosystem is calculated as per a formula (f):

$$EHI = P * {W}_{P} + C * {W}_{C} + B * {W}_{B}$$

where EHI represents the comprehensive score of the aquatic ecosystem, W_{P} represents a weight of the physical habitat, W_{C} represents a weight of the physicochemical properties, and W_{B} represents a weight of the aquatic organisms.

Specific processes of the step 4 are as follows.

The assessment standard levels consist of five levels corresponding to a health status of the aquatic ecosystem: very healthy, healthy, sub-healthy, unhealthy, and degraded.

The displaying the level result of the aquatic ecosystem is to display the health status of the aquatic ecosystem, based on the assessment standard levels and by using graphical annotations and pattern-based zoning.

An application method of the health assessment method of the aquatic ecosystem based on the ecological integrity is provided by the disclosure. By using the health assessment method can scientifically and comprehensively assess and manage and restore river or lake ecosystems.

A specific embodiment of the application method of the health assessment method of the aquatic ecosystem based on the ecological integrity is as follows.

Step 1, elements of the aquatic ecosystem are integrated to obtain criterion layers consisting of physical habitat, physicochemical properties, and aquatic organisms, and ecological baseline values of candidate indicators are obtained by using differentiated ecological baseline determination methods.

First, an assessment framework of “goal layer—criterion layer—element layer—indicator layer” is used to construct an indicator system consisting of the three criterion layers: the physical habitat, the physicochemical properties, and the aquatic organisms.

The goal layer is defined as the health assessment of the aquatic ecosystem, and the criterion layers respectively represent the physical habitat (P), the physicochemical properties (C), and the aquatic organisms (B). The elements for the physical habitat (P) include hydrological regime, spatial morphology, and riparian zone condition. The elements for the physicochemical properties (C) include water quality pollution and sediment pollution. The elements for the aquatic organisms (B) include phytoplankton integrity, zooplankton integrity, macroinvertebrate integrity, and fish integrity.

Then, the ecological baselines and the candidate indicators are determined.

In response to indicators corresponding to the physical habitat (P) and the fish integrity, a historical reference method is used; and in response to indicators corresponding to the physicochemical properties (C), the phytoplankton integrity, the zooplankton integrity, and the macroinvertebrate integrity, a reference site method is used.

When using the historical reference method, a historical state prior to human activity interference is used as an ecological baseline value. When using the reference site method, 16 sample sites (S1 to S16) are set up from upstream to downstream of the aquatic system. Based on a comprehensive consideration of the degree of human activity interference and the vegetation coverage of the riparian zone, S1, S2, S3, S5, and S8 are ultimately selected as reference sites to determine ecological baseline values.

When selecting the candidate indicators, a clear theoretical framework of the ecological integrity is relied upon to select candidate indicators that reflect the status of the aquatic ecosystem, including indicators of the physical habitat, indicators of the physicochemical properties, and indicators of the aquatic organisms. A total of 40 candidate indicators are ultimately obtained to comprehensively and accurately assess a health status of the aquatic ecosystem.

The candidate indicator corresponding to the hydrological regime is an ecological flow compliance rate (P₁), the candidate indicator corresponding to the spatial morphology is a water body connectivity (P₂), and the candidate indicator corresponding to the riparian zone condition is a natural proportion of riparian zone (P₃).

The candidate indicators corresponding to water quality pollution are ammonia nitrogen (C₁), total phosphorus (C₂), and a permanganate index (C₃).

The candidate indicators corresponding to sediment pollution are total phosphorus (C₄), a proportion of organic matter content (Cs), chromium (C₆), nickel (C₇), copper (C₈), zinc (C₉), arsenic (C₁₀), cadmium (C₁₁), and lead (C₁₂).

The candidate indicators corresponding to the phytoplankton integrity are a total number of taxonomic units (B₁), total density (B₂), total biomass (B₃), a proportion of Bacillariophyta density (B₄), a proportion of Cyanobacteria density (Bs), a proportion of Bacillariophyta biomass (B₆), a proportion of Chlorophyta biomass (B₇), and a Shannon-Wiener diversity index (B₈).

The candidate indicators corresponding to the zooplankton integrity are a total number of taxonomic units (B₉), total abundance (B₁₀), total biomass (B₁₁), and a Shannon-Wiener diversity index (B₁₂).

The candidate indicators corresponding to the macroinvertebrate integrity are a total number of taxonomic units (B₁₃), total abundance (B₁₄), total biomass (B₁₅), a Biological Monitoring Working Party (BMWP) index (B₁₆), Family Biotic Index (B₁₇), and a Shannon-Wiener diversity index (B₁₈).

The candidate indicators corresponding to the fish integrity are a number of native fish species (B₁₉), a proportion of invasive species (B₂₀), a proportion of rare or endemic species (B₂₁), a proportion of protected species (B₂₂), a proportion of fish species that lay drifting eggs (B₂₃), a proportion of piscivorous fish (B₂₄), and a proportion of omnivorous fish (B₂₅) (See Table 1 for details).

TABLE 1
the candidate indicators for the health assessment of
the aquatic ecosystem based on the ecological integrity

| criterion layer | element layer | indicator layer |
|---|---|---|
| physical habitat (P) | hydrological regime | ecological flow |
| | | compliance rate (P₁) |
| | spatial morphology | water body connectivity |
| | | (P₂) |
| | riparian zone | natural proportion of |
| | condition | riparian zone (P₃) |
| physicochemical | water quality | ammonia nitrogen (C₁), |
| properties (C) | pollution | total phosphorus (C₂), |
| | | permanganate index (C₃) |
| | sediment pollution | total phosphorus (C₄), |
| | | proportion of organic |
| | | matter content (C₅), |
| | | chromium (C₆), nickel |
| | | (C₇), copper (C₈), zinc |
| | | (C₉), arsenic (C₁₀), |
| | | cadmium (C₁₁), lead (C₁₂) |
| aquatic | phytoplankton | total number of taxonomic |
| organisms (B) | integrity | units (B₁), total density |
| | | (B₂), total biomass (B₃), |
| | | proportion of |
| | | Bacillariophyta density |
| | | (B₄), proportion of |
| | | Cyanobacteria density |
| | | (B₅), proportion of |
| | | Bacillariophyta biomass |
| | | (B₆), proportion of |
| | | Chlorophyta biomass (B₇), |
| | | Shannon-Wiener diversity |
| | | index (B₈) |
| | zooplankton | total number of taxonomic |
| | integrity | units (B₉), total abundance |
| | | (B₁₀), total biomass (B₁₁), |
| | | Shannon-Wiener diversity |
| | | index (B₁₂) |
| | macroinvertebrate | total number of taxonomic |
| | integrity | units (B₁₃), total |
| | | abundance (B₁₄), total |
| | | biomass (B₁₅), Biological |
| | | Monitoring Working Party |
| | | (BMWP) index (B₁₆), |
| | | Family Biotic Index (B₁₇), |
| | | Shannon-Wiener diversity |
| | | index (B₁₈) |
| | fish integrity | number of native fish |
| | | species (B₁₉), proportion |
| | | of invasive species (B₂₀), |
| | | proportion of rare or |
| | | endemic species (B₂₁), |
| | | proportion of protected |
| | | species (B₂₂), proportion |
| | | of fish species that lay |
| | | drifting eggs (B₂₃), |
| | | proportion of piscivorous |
| | | fish (B₂₄), proportion of |
| | | omnivorous fish (B₂₅) |

Step 2, applicability verification, sensitivity verification, and redundancy verification are sequentially performed on the candidate indicators in that order to select the core indicators from the candidate indicators.

1) Applicability verification: a coefficient of variation for each of the candidate indicators is calculated as per the following formula: Cᵥ=σ/μ, where μ represents a standard deviation of each of the candidate indicators, and σ represents an average value of each of the candidate indicators. Weak variation indicators P₂, C₃ and C₇ with the coefficient of variation Cᵥ≤0.15 are removed to obtain applicability-verified candidate indicators, as shown in FIG. 5.

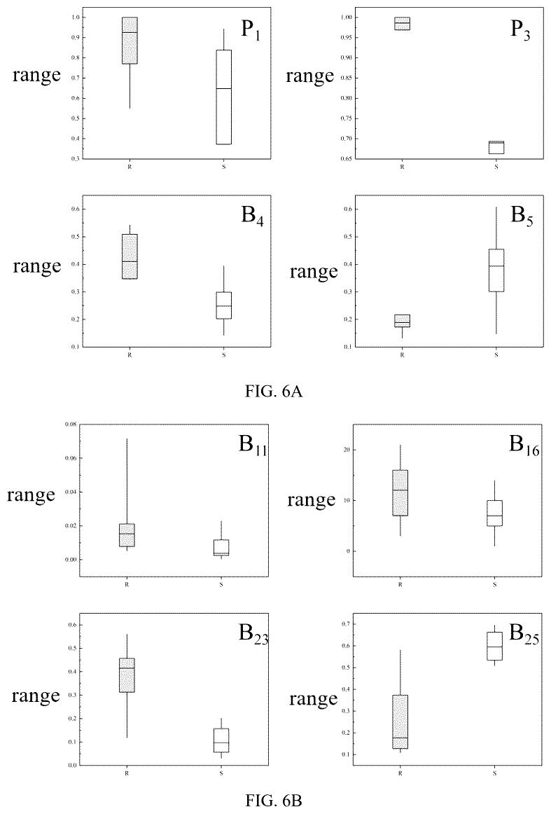

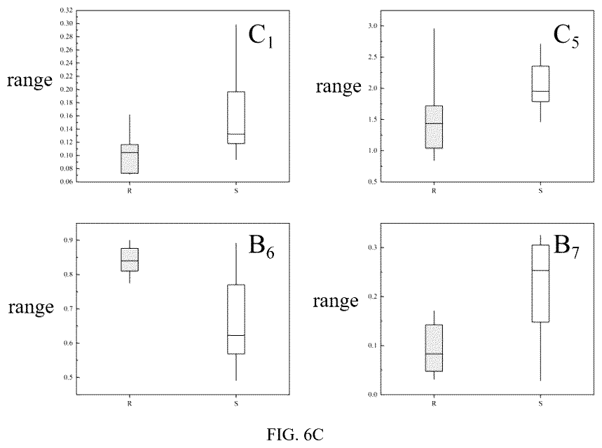

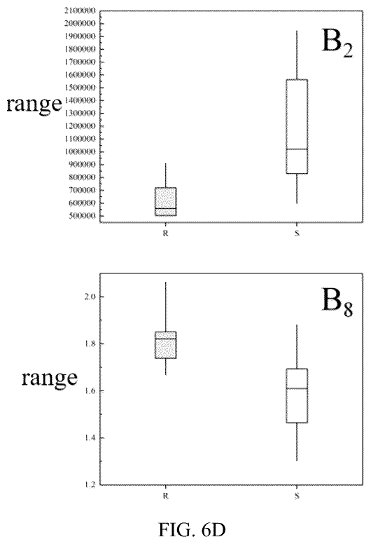

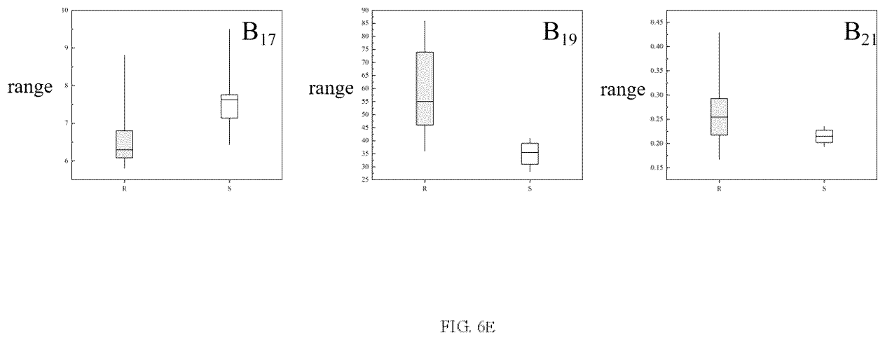

2) Sensitivity verification: a boxplot method is used to compare ecological baseline values R and sample values S of the applicability-verified candidate indicators, and only applicability-verified candidate indicators with IQ≥2 are retained. The final retained indicators (i.e., sensitivity-verified candidate indicators) are P₁, P₃, C₁, C₅, B₂, B₄, B₅, B₆, B₇, B₈, B₁₁, B₁₆, B₁₇, B₁₉, B₂₁, B₂₃, and B₂₅, as shown in FIGS. 6A-6E.

3) Redundancy verification: a Pearson correlation analysis is performed using IBM SPSS Statistics 26 on the 17 sensitivity-verified candidate indicators, as shown in Table 2. Two candidate indicators of the 17 sensitivity-verified candidate indicators with a correlation coefficient |r|≥0.95 are evaluated for redundancy. Considering a number of highly correlated indicators and the completeness of the criterion layers of the assessment indicator system, the core indicators P₁, P₃, C₁, B₂, B₄, B₅, B₈, B₁₁, B₁₇, B₁₉, B₂₁, B₂₃, and B₂₅ are ultimately retained.

TABLE 2
correlation coefficients of the 17 sensitivity-verified indicators

| | P₁ | P₃ | C₁ | C₅ | B₂ | B₄ | B₅ | B₆ | B₇ | B₈ | B₁₁ | B₁₆ | B₁₇ | B₁₉ | B₂₁ | B₂₃ | B₂₅ |
|---|---|---|---|---|---|---|---|---|---|---|---|---|---|---|---|---|---|
| P₁ | 1.00 | | | | | | | | | | | | | | | | |
| P₃ | −0.45 | 1.00 | | | | | | | | | | | | | | | |
| C₁ | 0.86 | 0.06 | 1.00 | | | | | | | | | | | | | | |
| C₅ | 0.65 | −0.10 | 0.58 | 1.00 | | | | | | | | | | | | | |
| B₂ | 0.83 | −0.78 | 0.44 | 0.68 | 1.00 | | | | | | | | | | | | |
| B₄ | −0.58 | −0.14 | −0.81 | 0.02 | −0.04 | 1.00 | | | | | | | | | | | |
| B₅ | −0.19 | 0.16 | 0.01 | −0.82 | −0.52 | −0.60 | 1.00 | | | | | | | | | | |
| B₆ | −0.86 | −0.06 | −1.00 | −0.58 | −0.44 | 0.80 | 0.00 | 1.00 | | | | | | | | | |
| B₇ | 0.87 | 0.01 | 0.96 | 0.79 | 0.57 | −0.60 | −0.28 | −0.96 | 1.00 | | | | | | | | |
| B₈ | −0.87 | 0.00 | −0.94 | −0.82 | −0.59 | 0.56 | 0.33 | 0.94 | −1.00 | 1.00 | | | | | | | |
| B₁₁ | −0.70 | 0.08 | −0.64 | −0.996 | −0.69 | 0.07 | 0.76 | 0.65 | −0.84 | 0.86 | 1.00 | | | | | | |
| B₁₆ | 0.79 | −0.05 | 0.79 | 0.96 | 0.67 | −0.27 | −0.62 | −0.79 | 0.93 | −0.95 | −0.98 | 1.00 | | | | | |
| B₁₇ | −0.26 | −0.17 | −0.50 | 0.42 | 0.24 | 0.91 | −0.87 | 0.49 | −0.23 | 0.18 | −0.34 | 0.15 | 1.00 | | | | |
| B₁₉ | 0.90 | −0.57 | 0.64 | 0.83 | 0.958 | −0.18 | −0.56 | −0.64 | 0.77 | −0.79 | −0.84 | 0.85 | 0.18 | 1.00 | | | |
| B₂₁ | 0.64 | 0.38 | 0.90 | 0.72 | 0.25 | −0.58 | −0.24 | −0.90 | 0.93 | −0.93 | −0.76 | 0.86 | −0.24 | 0.52 | 1.00 | | |
| B₂₃ | −0.37 | −0.03 | −0.32 | −0.95 | −0.52 | −0.29 | 0.93 | 0.33 | −0.57 | 0.62 | 0.92 | −0.83 | −0.65 | −0.65 | −0.57 | 1.00 | |
| B₂₅ | −0.41 | 0.46 | −0.30 | 0.43 | −0.19 | 0.68 | −0.74 | 0.29 | −0.07 | 0.03 | −0.37 | 0.22 | 0.79 | −0.09 | 0.14 | −0.69 | 1.00 |

Step 3, a comprehensive score of the aquatic ecosystem is obtained by weighting and summing the criterion layers using a method combining an entropy weight method and an analytic hierarchy process.

Step 301, data of the core indicators are normalized.

The data of the selected 13 core indicators are normalized according to different types of the core indicator, as shown in Table 3.

TABLE 3
indicator types and normalization formulas

| indicator type | specific indicators | calculation formula |
|---|---|---|
| positive indicator | P₁, P₃, B₄, B₈, B₁₁, B₁₉, | s = (x − xₘᵢₙ)/(xₘₐₓ − xₘᵢₙ) |
| | B₂₁, B₂₃ | |
| negative indicator | C₁, B₂, B₅, B₁₇, B₂₅ | s = (xₘₐₓ − x)/(xₘₐₓ − xₘᵢₙ) |

In the above formulas, s represents a normalized value of each of the core indicators, x represents a measured value of each of the core indicators, xₘₐₓ represents a maximum measured value of each of the core indicators, and xₘᵢₙ represents a minimum measured value of each of the core indicators.

Step 302, the core indicators are weighted by using the entropy weight method, and a score of each of the criterion layers is calculated through weighted summation.

The entropy weight method determines a weight of the each of the core indicators based on an amount of information contained, and calculation steps are as follows.

(1) Assume there are m sample points and n indicators, and a matrix S is constructed based on scoring of the core indicators:

$$S = {( {s}_{ij} )}_{m \times n}$$

(2) A characteristic weight pᵢⱼ of a j-th indicator at a i-th sample point is calculated to measure the amount of information contained as per the following formula:

$${p}_{ij} = \frac{{s}_{ij}}{{\sum }_{i = 1}^{m} {s}_{ij}}$$

(3) An information entropy eⱼ and a difference coefficient dⱼ of the j-th indicator are calculated as per the following formulas. The greater the dispersion of the indicator, the more information it contains, resulting in a smaller eⱼ and a larger dⱼ, and thus a larger corresponding weight value.

$${e}_{j} = - {ln ( m )}^{- 1} {\sum }_{i = 1}^{m} {p}_{ij} ln ( {p}_{ij} )$$

$${d}_{j} = 1 - {e}_{j}$$

(4) Finally, a weight wⱼ of each of the indicators is calculated based on the above result as per the following formula:

$${w}_{j} = \frac{{d}_{j}}{{\sum }_{j = 1}^{n} {d}_{j}}$$

(5) A score for the physical habitat, a score for the physicochemical properties, and a score for the aquatic organisms are calculated as per formulars (c), (d), and (e), respectively, as shown in Table 4.

$$P = 100 * \sum ( {p}_{i} * {w}_{pi} ) \qquad ( c )$$

$$C = 10 \; 0 * \sum ( {c}_{i} * {w}_{ci} ) \qquad ( d )$$

$$B = 10 \; 0 * \sum ( {b}_{i} * {w}_{bj} ) \qquad ( e )$$

where P represents the score for the physical habitat, pᵢ represents a normalized value of a i-th indicator of the physical habitat, and wₚᵢ represents a weight of the i-th indicator of the physical habitat; C represents the score for the physicochemical properties, c; represents a normalized value of a i-th indicator of the physicochemical properties, and w_{ci} represents a weight of the i-th indicator of the physicochemical properties; and B represents the score for the aquatic organisms, bᵢ represents a normalized value of a i-th indicator of the aquatic organisms, and w_{bj} represents a weight of the i-th indicator of the aquatic organisms.

TABLE 4
indicator weights and the score of each of the criterion layers

| criterion layer | indicator layer | weight value | criteria score |
|---|---|---|---|
| physical habitat | P₁ | 70.29% | 51.26 |
| | P₃ | 29.71% | |
| physicochemical | C₁ | 100.00% | 70.79 |
| properties | | | |
| | B₂ | 0.10% | |
| | B₄ | 1.21% | |
| | B₅ | 0.19% | |
| | B₈ | 0.54% | |
| | B₁₁ | 25.90% | |
| | B₁₇ | 0.19% | |
| | B₁₉ | 16.51% | |
| | B₂₁ | 17.36% | |
| | B₂₃ | 19.93% | |
| | B₂₅ | 18.05% | |

Step 303, each of the criterion layers is weighted by using the analytic hierarchy process to calculate the comprehensive score of the aquatic ecosystem.

The analytic hierarchy process divides a problem structure into three levels by combining qualitative and quantitative methods. It then quantitatively compares relative importance of each of the indicators, constructs a matrix, and calculates indicator weights. There are three main steps.

(1) A judgment matrix X is constructed by comparing the indicators pairwise to determine the relative importance of two indicators, and the judgement matrix is as follows:

$$X = [ \begin{matrix}{x}_{11} & {x}_{12} & … & {x}_{1 n} \\ {x}_{21} & {x}_{22} & … & {x}_{2 n} \\ … & & & … \\ {x}_{n 1} & {x}_{n 2} & … & {x}_{n n}\end{matrix} ]$$

where xᵢ and xⱼ represent i-th and j-th indicators, respectively, and xᵢⱼ represents the relative importance of the i-th indicator compared to the j-th indicator. The weighting in the analytic hierarchy process typically employs a nine-point scale for quantitative description, as shown in Table 5.

TABLE 5
meaning of the nine-point scale

| scale of xᵢⱼ assignment | meaning |
|---|---|
| 1 | the i-th indicator is equally important as |
| | the j-th indicator |
| 3 | the i-th indicator is slightly more |
| | important than the j-th indicator |
| 5 | the i-th indicator is significantly more |
| | important than the j-th indicator |
| 7 | the i-th indicator is strongly more |
| | important than the j-th indicator |
| 9 | the i-th indicator is extremely more |
| | important than the j-th indicator |
| 2, 4, 6, 8 | the i-th indicator is intermediate in |
| | importance between the above two |
| | levels compared to the j-th indicator |
| reciprocal (xⱼᵢ = 1/xᵢⱼ) | the importance of the j-th indicator |
| | relative to the i-th indicator |

TABLE 6
weight matrix of the criterion layers

| | physical | physicochemical | aquatic |
|---|---|---|---|
| | habitat | properties | organisms |
| physical habitat | 1 | 1 | 0.2 |
| physicochemical | 1 | 1 | 0.2 |
| properties | | | |
| aquatic organisms | 5 | 5 | 1 |

### (2) Calculation of a Weight Vector and a Maximum Eigenvalue

First, a N-th root w̅ₗ̅ of a product of each element in every row of the judgment matrix X is calculated as per the following formula:

$$\overline{{w}_{l}} = \sqrt[n]{{\prod }_{j = 1}^{n} {x}_{ij}} , i = 1 , 2 , ... , n$$

Then the above results are normalized to calculate the weight of each of the criterion layer wᵢ, and the weight vector W is obtained:

$${w}_{i} = \frac{\overline{{w}_{l}}}{{\sum }_{i = 1}^{n} \overline{{w}_{l}}} , i = 1 , 2 , ... , n$$

$$W = {[ {w}_{1} , {w}_{2} , ... , {w}_{n} ]}^{T}$$

Finally, according to a simplified calculation method, the maximum eigenvalue λₘₐₓ of the judgment matrix X is calculated as per the following formula:

$${λ}_{max} = {\sum }_{i = 1}^{n} \frac{{( X \cdot W )}_{i}}{{( X \cdot W )}_{i}}$$

### (3) Consistency Verification

To ensure the scientific nature and effectiveness of the weighting results and avoid judgment errors caused by incorrect weighting, it is necessary to verify the consistency of the judgment matrix. This is generally performed by calculating a random consistency ratio (C.R.) of the indicators. First, a negative average value of the other eigenvalues of the judgment matrix is calculated, excluding the maximum eigenvalue, which is referred to as a consistency index (C.I.):

$$C . I . = \frac{{λ}_{max} - n}{n - 1}$$

To measure whether the consistency of the judgment matrix is within an acceptable error range, an average random consistency index (R.I.) is introduced. In this embodiment, the order of the judgment matrix is 3, and R.I.=0.52. The random consistency ratio (C.R.) is calculated as per the following formula. If C.R.<0.1, the verification is passed; otherwise, it is not passed, and the judgment matrix needs to be reconstructed until the consistency verification is passed.

$$C . R . = \frac{C . I .}{R . I .}$$

The weight matrix of the indicator system is shown in Table 6 above. The weights for the physical habitat, the physicochemical properties, and the aquatic organisms are 14.29%, 14.29%, and 71.43%, respectively. The consistency ratio (C.R.) is less than 0.1, indicating that the matrix passes the consistency test.

The comprehensive score of the ecosystem is calculated as per the formula (f), and the comprehensive score of the ecosystem is 47.26.

$$E H I = P * {W}_{P} + C * {W}_{C} + B * {W}_{B}$$

where EHI represents the comprehensive score of the aquatic ecosystem, W_{P} represents a weight of the physical habitat, W_{C} represents a weight of the physicochemical properties, and W_{B} represents a weight of the aquatic organisms.

Step 4, a level result of the aquatic ecosystem is determined according to the comprehensive score of the aquatic ecosystem and assessment standard levels, and the level result of the aquatic ecosystem is displayed.

Step 401, the assessment standard levels consist of five levels corresponding to the health status of the aquatic ecosystem: very healthy, healthy, sub-healthy, unhealthy, and degraded.

In this embodiment, a score in a range of (80,100] is set as very healthy, a score in a range of (60,80] is set as healthy, a score in a range of (40, 60] is set as sub-healthy, a score in a range of (20, 40] is set as unhealthy, and a score in a range of [0, 20] is set as degraded.

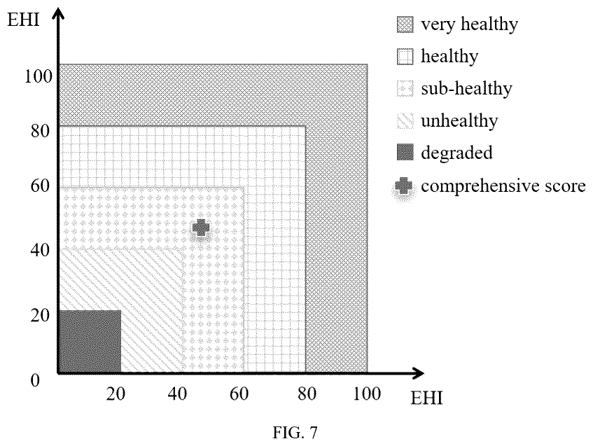

The comprehensive score of the aquatic ecosystem, calculated as per the formula (f), is 47.26, indicating a sub-healthy state, as shown in FIG. 7. In actual use, brown solid fill indicates degraded, yellow hatched fill indicates unhealthy, blue dotted fill indicates sub-healthy, green checkered indicates healthy, and dark green shaded fill indicates very healthy.

The disclosure provides the health assessment method of the aquatic ecosystem based on the ecological integrity. It constructs a comprehensive assessment index system that includes the three criterion layers: the physical habitat, the physicochemical properties, and the aquatic organisms. This method relies on the ecological integrity and uses the differentiated ecological baselines determination methods based on the different types of the candidate indicators, thereby providing more scientific ecological baseline values. This method combines subjective and objective weighting methods to assign weights and scores to each indicator and each of the criterion layers. Specifically, for each of the criterion layers, where the amount of indicator data is large and the decision-making criteria are clear, the entropy weight method is used for weighting. For calculating the comprehensive score of the aquatic ecosystem, t the analytic hierarchy process is used for weighting, guided by ecological management needs and the characteristics of the ecological region, making the weighting structure more accurate. Finally, it visually and intuitively represents the health status of the aquatic ecosystem through graphical annotations and pattern-based zoning.

content is an explanation of the specific embodiment of the disclosure, which can help those skilled in the art to fully understand the technical solution of the disclosure. However, the embodiment is only illustrative and cannot be considered as limiting the specific embodiment of the disclosure to the description of the embodiment. For those skilled in the art to which the disclosure belongs, without departing from the concept of the disclosure, several simple deductions and transformations can be made, which should be considered as belonging to the scope of protection of the disclosure.

What is claimed is:

1. A health assessment method of an aquatic ecosystem based on ecological integrity, comprising:
step 1, determining criteria consisting of physical habitat, physicochemical properties, and aquatic organisms of the aquatic ecosystem to obtain criterion layers, and obtaining ecological baseline values of candidate indicators by using differentiated ecological baseline determination methods;
step 2, sequentially performing applicability verification, sensitivity verification, and redundancy verification on the candidate indicators in that order to select core indicators from the candidate indicators;
step 3, performing weighting and summing on the criterion layers of the aquatic ecosystem by using a method combining an entropy weight method and an analytic hierarchy process, to thereby obtain a comprehensive score of the aquatic ecosystem; and
step 4, determining a level result of the aquatic ecosystem according to the comprehensive score of the aquatic ecosystem and assessment standard levels and displaying the level result of the aquatic ecosystem.

2. The health assessment method of the aquatic ecosystem based on the ecological integrity as claimed in claim 1, wherein the obtaining ecological baseline values of candidate indicators by using differentiated ecological baseline determination methods comprises:
in response to a target candidate indicator of the candidate indicators being an indicator of a site with a lower variability, a stronger continuity, or a slower response to external stressors, determining an ecological baseline of the target candidate indicator by using a historical reference method, and using a historical state of the site prior to human activity interference as an ecological baseline value of the target candidate indicator;
in response to a target candidate indicator of the candidate indicators being an indicator of a site with a higher variability, a poorer continuity, or a faster response to external stressors, determining an ecological baseline of the target candidate indicator by using a reference site method, and using a state of a site with a minimal human disturbance of sampling sites as an ecological baseline value of the target candidate indicator.

3. The health assessment method of the aquatic ecosystem based on the ecological integrity as claimed in claim 1, wherein the performing applicability verification comprises:
calculating a coefficient of variation for each of the candidate indicators as per the following formula: Cᵥ=σ/μ, where μ represents a standard deviation of each of the candidate indicators, and σ represents an average value of each of the candidate indicators; and removing all candidate indicators with the coefficient of variation Cᵥ≤0.15 from the candidate indicators to obtain applicability-verified candidate indicators;
wherein the performing sensitivity verification comprises:
comparing ecological baseline values R and sample values S of the applicability-verified candidate indicators by using a boxplot method; and removing applicability-verified candidate indicators with an indicator quality (IQ) less than 2 from the applicability-verified candidate indicators to obtain sensitivity-verified candidate indicators; and
wherein the performing redundancy verification comprises:
performing a Pearson correlation analysis on the sensitivity-verified candidate indicators; and in response to two candidate indicators of the sensitivity-verified candidate indicators having a correlation coefficient |r|≥0.95, retaining only one of the two candidate indicators of the sensitivity-verified candidate indicators.

4. The health assessment method of the aquatic ecosystem based on the ecological integrity as claimed in claim 1, wherein the step 3 comprises:
step 301, normalizing data of the core indicators;
step 302, weighting the core indicators by using the entropy weight method, and calculating a score of each of the criterion layers through weight summation; and
step 303, weighting each of the criterion layers by using the analytic hierarchy process, thereby calculating the comprehensive score of the aquatic ecosystem.

5. The health assessment method of the aquatic ecosystem based on the ecological integrity as claimed in claim 4, wherein the normalizing data of the core indicators comprises:
for a target core indicator being a positive indicator of the core indicators, normalizing data of the target core indicator as per a formula (a):
$$s = ( x - {x}_{min} ) / ( {x}_{max} - {x}_{min} ) \qquad ( a )$$
for a target core indicator being a negative indicator of the core indicators, normalizing data of the target core indicator as per a formula (b):
$$s = ( {x}_{max} - x ) / ( {x}_{max} - {x}_{min} ) \qquad ( b )$$
where s represents a normalized value of the target core indicator, x represents a measured value of the target core indicator, xₘₐₓ represents a maximum measured value of the target core indicator, and xₘᵢₙ represents a minimum measured value of the target core indicator.

6. The health assessment method of the aquatic ecosystem based on the ecological integrity as claimed in claim 4, wherein the weighting the core indicators by using the entropy weight method, and calculating a score of each of the criterion layers through weight summation comprises:
weighting the core indicators of each of the criterion layers by using the entropy weight method; and calculating the score of each of the criterion layers as per formulas (c), (d), and (e), respectively:
$$P = 10 \; 0 * \sum ( {p}_{i} * {w}_{pi} ) \qquad ( c )$$
$$C = 100 * \sum ( {c}_{i} * {w}_{ci} ) \qquad ( d )$$
$$B = 100 * \sum ( {b}_{i} * {w}_{bj} ) \qquad ( e )$$
where P represents a score for the physical habitat, pᵢ represents a normalized value of a i-th indicator of the physical habitat, and wₚᵢ represents a weight of the i-th indicator of the physical habitat; C represents a score for the physicochemical properties, ci represents a normalized value of a i-th indicator of the physicochemical properties, and w_{ci} represents a weight of the i-th indicator of the physicochemical properties; and B represents a score for the aquatic organisms, bᵢ represents a normalized value of a i-th indicator of the aquatic organisms, and w_{bj} represents a weight of the i-th indicator of the aquatic organisms.

7. The health assessment method of the aquatic ecosystem based on the ecological integrity as claimed in claim 4, wherein the comprehensive score of the aquatic ecosystem is calculated as per a formula (f):
$$E H I = P * {W}_{P} + C * {W}_{C} + B * {W}_{B}$$
where EHI represents the comprehensive score of the aquatic ecosystem, W_{P} represents a weight of the physical habitat, W_{C} represents a weight of the physicochemical properties, and W_{B} represents a weight of the aquatic organisms.

8. The health assessment method of the aquatic ecosystem based on the ecological integrity as claimed in claim 1, wherein the assessment standard levels consist of five levels corresponding to a health status of the aquatic ecosystem: very healthy, healthy, sub-healthy, unhealthy, and degraded.

9. The health assessment method of the aquatic ecosystem based on the ecological integrity as claimed in claim 1, wherein the displaying the level result of the aquatic ecosystem comprises:
displaying a health status of the aquatic ecosystem, based on the assessment standard levels and by using graphical annotations and pattern-based zoning.

10. An application method of the health assessment method of the aquatic ecosystem based on the ecological integrity as claimed in claim 1, comprising:
assessing health statuses of river or lake ecosystems using the health assessment method, and
managing and restoring the river or lake ecosystems using health assessment method.
